(19) United States
(12) Patent Application Publication
(10) Pub. No.: US 2019/0227866 A1
(43) Pub. Date: Jul. 25, 2019

(54) INFORMATION PROCESSING DEVICE AND METHOD

(71) Applicant: SONY CORPORATION, TOKYO (JP)

(72) Inventor: KAZUHIKO TAKABAYASHI, TOKYO (JP)

(21) Appl. No.: 16/328,941

(22) PCT Filed: Sep. 29, 2017
(86) PCT No.: PCT/JP2017/035399

§ 371 Date: Feb. 27, 2019

(30) Foreign Application Priority Data
Oct. 14, 2016 (JP) 2016-202989

(51) Int. Cl. G06F 11/07; H04N 21/24; H04N 21/845; H04N 21/2387; H04L 29/06

(52) U.S. Cl. CPC G06F 11/0793; H04N 21/2404; H04L 65/4084; H04N 21/2387; H04N 21/8456

(57) ABSTRACT

The present disclosure relates to an information processing device and method capable of repairing corrupted data of a file more easily. As a response to a request related to a file with incomplete data, information regarding a repair situation of the file is provided to a request source. In addition, information regarding a repair situation of a file with incomplete data is acquired, the information being supplied as a response to a request, and control related to acquisition of the file is performed, on the basis of the acquired information regarding the repair situation. The present disclosure can be applied to, for example, an information processing device, a reception device, a playback device, or the like.

### TECHNICAL FIELD

The present disclosure relates to an information processing device and method, and particularly relates to an information processing device and method capable of repairing corrupted data of a file more easily.

### BACKGROUND ART

Conventionally, a file of the ISO base media file format may be transmitted by a transmission scheme that may involve packet loss or the like, such as multicast/broadcast (multimedia multicast and broadcast service (MBMS)) of a mobile network or broadcasting (e.g., Advanced Television Systems Committee (ATSC) 3.0). In that case, part of data is not recovered even by forward error correction (FEC) processing or the like on the reception side, and a file in which data is partly corrupted (also referred to as partial file) may be generated. In such a file, information indicating a portion where data is corrupted and information for repair (the uniform resource locator (URL) of a transmission source file, etc.) are held (e.g., see Non-Patent Literature 1).

Furthermore, after the reception and accumulation, repair of complementing a data corruption portion can be performed by unicast transmission, and a repair situation during the process may be recorded in the partial file.

### CITATION LIST

### Non-Patent Literature

Non-Patent Literature 1: Jean Le Feuvre, Telecom ParisTech, WD of Partial File Storage, INTERNATIONAL ORGANISATION FOR STANDARDISATION ORGANISATION INTERNATIONALE DE NORMALISATION ISO/IEC JTC1/SC29/WG11 CODING OF MOVING PICTURES AND AUDIO, ISO/IEC JTC1/SC29/WG11, N16167, June 2016

### DISCLOSURE OF INVENTION

### Technical Problem

However, in response to a request for the partial file from an application client, information regarding a repair situation of the partial file cannot be provided. Consequently, a client cannot obtain information regarding a data corruption portion in a file until this information is actually processed (decoded). Therefore, whether to use the file or re-acquire another substitute file cannot be speedily determined, which may make it difficult to repair corrupted data of a file.

The present disclosure has been made in view of such circumstances and aims to enable corrupted data of a file to be repaired more easily.

### Solution to Problem

An information processing device of an aspect of the present technology is an information processing device including: a response processing unit configured to provide, as a response to a request related to a file with incomplete data, information regarding a repair situation of the file to a request source.

The information regarding the repair situation can include a status of repair processing of the file, and information indicating the number of blocks of unrepaired corrupted data of the file.

The status can include information indicating whether or not repair has been started, information indicating whether or not repair has been finished, and information indicating whether or not repair has failed.

The information regarding the repair situation can further include information indicating the number of bytes of unrepaired corrupted data of the file.

The response processing unit can provide the information regarding the repair situation of the file to the request source by adding the information to a header of the response as a HyperText Transfer Protocol (HTTP) header.

The response processing unit can provide the information regarding the repair situation of the file to the request source as a Server and network assisted DASH (SAND) message of Moving Picture Experts Group Dynamic Adaptive Streaming over HyperText Transfer Protocol (MPEG DASH).

The response processing unit can further provide information regarding a repair situation of a file of another segment, in addition to information regarding a repair situation of a file of a requested segment, by the SAND message.

The response processing unit can provide the information regarding the repair situation of the file by using a ResourceStatus message of the SAND message.

The response processing unit can provide the information regarding the repair situation of the file by using an extension message of the SAND message.

An information processing method of the aspect of the present technology is an information processing method including: providing, as a response to a request related to a file with incomplete data, information regarding a repair situation of the file to a request source.

An information processing device of another aspect of the present technology is an information processing device including: an acquisition unit configured to acquire information regarding a repair situation of a file with incomplete data, the information being supplied as a response to a request; and a control unit configured to perform control related to acquisition of the file, on the basis of the information regarding the repair situation acquired by the acquisition unit.

The control unit can select, on the basis of the information regarding the repair situation, an acquisition destination of the file from a supply source of the file and a supply source of the response to which the file is supplied from the supply source of the file, and the acquisition unit can further acquire the file from the acquisition destination selected by the control unit.

The control unit can select the acquisition destination of the file on the basis of a proportion of unrepaired corrupted data of the file.

The control unit can select the acquisition destination of the file further on the basis of the number of blocks of unrepaired corrupted data of the file.

A repair unit configured to repair unrepaired corrupted data of the file can be further included. In a case where the control unit selects the supply source of the response as the acquisition destination of the file, the acquisition unit can acquire the file from the supply source of the response, and further acquire data corresponding to the corrupted data from the supply source of the file, and the repair unit can repair corrupted data of the file acquired by the acquisition unit by using the data acquired by the acquisition unit.

The acquisition unit can acquire the information regarding the repair situation supplied as a HyperText Transfer Protocol (HTTP) header.

The acquisition unit can acquire the information regarding the repair situation supplied as a Server and network assisted DASH (SAND) message of Moving Picture Experts Group Dynamic Adaptive Streaming over HyperText Transfer Protocol (MPEG DASH).

The control unit can cause the file to be acquired after waiting in accordance with surplus time before playback of the file.

The acquisition unit can acquire the information regarding the repair situation supplied as a response to a HyperText Transfer Protocol (HTTP) HEAD Request or an HTTP GET Request.

An information processing method of the other aspect of the present technology is an information processing method including: acquiring information regarding a repair situation of a file with incomplete data, the information being supplied as a response to a request; and performing control related to acquisition of the file, on the basis of the acquired information regarding the repair situation.

In an information processing device and method according to an aspect of the present technology, as a response to a request related to a file with incomplete data, information regarding a repair situation of the file is provided to a request source.

In an information processing device and method according to another aspect of the present technology, information regarding a repair situation of a file with incomplete data is acquired, the information being supplied as a response to a request, and control related to acquisition of the file is performed, on the basis of the acquired information regarding the repair situation.

### Advantageous Effects of Invention

According to the present disclosure, information can be processed. In particular, corrupted data of a file can be repaired more easily.

### BRIEF DESCRIPTION OF DRAWINGS

FIG. 1 illustrates a main configuration example of a communication system.

FIG. 2 is a block diagram illustrating a main configuration example of a reception device.

FIG. 3 illustrates a main configuration example of Partial File Container Box.

FIG. 4 illustrates an example of syntax of Partial File Block Map Box.

FIG. 5 illustrates examples of semantics of flags and recovered_flags.

FIG. 6 is a flowchart for describing an example of a main flow of file repair processing.

FIG. 7 is a flowchart for describing an example of a main flow of response processing.

FIG. 8 illustrates an example of an HTTP header.

FIG. 9 illustrates an example of a prescription related to a ResourceStatus message of a SAND message of MPEG DASH.

FIG. 10 illustrates examples of a request and a response using a ResourceStatus message.

FIG. 11 is a flowchart for describing an example of a main flow of response processing.

FIG. 12 illustrates an example of a prescription related to a ResourceRepairStatus message of a SAND message of MPEG DASH.

FIG. 13 illustrates an example of semantics of each status.

FIG. 14 illustrates an example of a response using a ResourceRepairStatus message.

FIG. 15 is a flowchart for describing an example of a main flow of file acquisition processing.

FIG. 16 is a flowchart for describing an example of a main flow of file acquisition processing.

FIG. 17 is a flowchart for describing an example of a main flow of file acquisition processing.

FIG. 18 is a block diagram illustrating a main configuration example of a computer.

### MODE(S) FOR CARRYING OUT THE INVENTION

Modes for carrying out the present disclosure (hereinafter referred to as embodiments) are described below. Note that description is given in the following order.
1. First embodiment (communication system)
2. Others

### 1. First Embodiment

### <File Including Corrupted Data>

Conventionally, a file of the ISO base media file format may be transmitted by a transmission scheme that may involve packet loss or the like, such as multicast/broadcast (multimedia multicast and broadcast service (MBMS)) of a mobile network or broadcasting (e.g., Advanced Television Systems Committee (ATSC) 3.0). In that case, part of data is not recovered even by forward error correction (FEC) processing or the like on the reception side, and a file in which data is partly corrupted (also referred to as partial file) may be generated. For example, as described in Non-Patent Literature 1, in regard to such a file, information indicating a portion where data is corrupted and information for repair (the URL of a transmission source file, etc.) may be held. Furthermore, after the reception and accumulation, repair of complementing a data corruption portion can be performed by unicast transmission, and a repair situation during the process may be recorded in the partial file.

Incidentally, 3GPP prescribes, on the assumption of handling of a partial file between a client and a proxy, that the following content type (content-type) is designated by a HyperText Transfer Protocol (HTTP) extension header (e.g., see 3GPP TS 26.247 http://www.arib.or.jp/english/html/overview/doc/STD-T63V12_00/5_Appendix/Rel13/26/26247-d20.pdf).

Accept: application/3gpp-partial
Content-type: application/3gpp-partial

Among these, the former one is used to show that a partial file is accepted (processable) from the client to the proxy, and the latter one is used to show that a file sent back as a response is a partial file from the proxy to the client.

In addition, Moving Picture Experts Group Dynamic Adaptive Streaming over HTTP (MPEG DASH) defines a status message for a proxy or a CDN edge server in this case to report a cash situation (availability) of a DASH segment to a client, in Server and Network Assisted DASH (SAND) (e.g., see ISO/IEC JTC 1/SC 29/WG 11, Information Technology—Dynamic adaptive streaming over HTTP (DASH)—Part 5: Server and network assisted DASH (SAND), FDIS ISO/IEC 23009-5, N15991, 2015-02-19).

However, information regarding a repair situation of a partial file, such as that the partial file is under repair processing, and how much of a data corruption portion is left, cannot be provided to a client. Consequently, a client cannot obtain information regarding a data corruption portion in a file until this information is actually processed (decoded). Therefore, whether to use the file or re-acquire another substitute file cannot be speedily determined, which may make it difficult to repair corrupted data of a file.

In addition, in the case where a file requested by a client is a media segment of MPEG DASH, and a segment temporally after the segment is a partial file, this fact cannot be reported to the client in advance. In addition, also in the case where a media segment of another representation in the same adaptation set as the requested segment is a partial file, this fact cannot be reported to the client in advance.

### <Notification of Repair Situation>

Hence, as a response to a request related to a file with incomplete data, information regarding a repair situation of the file is provided to the request source. In this manner, a client can acquire information regarding a repair situation of a partial file more easily, and thus can repair corrupted data of the file more easily on the basis of the information.

### <Communication System>

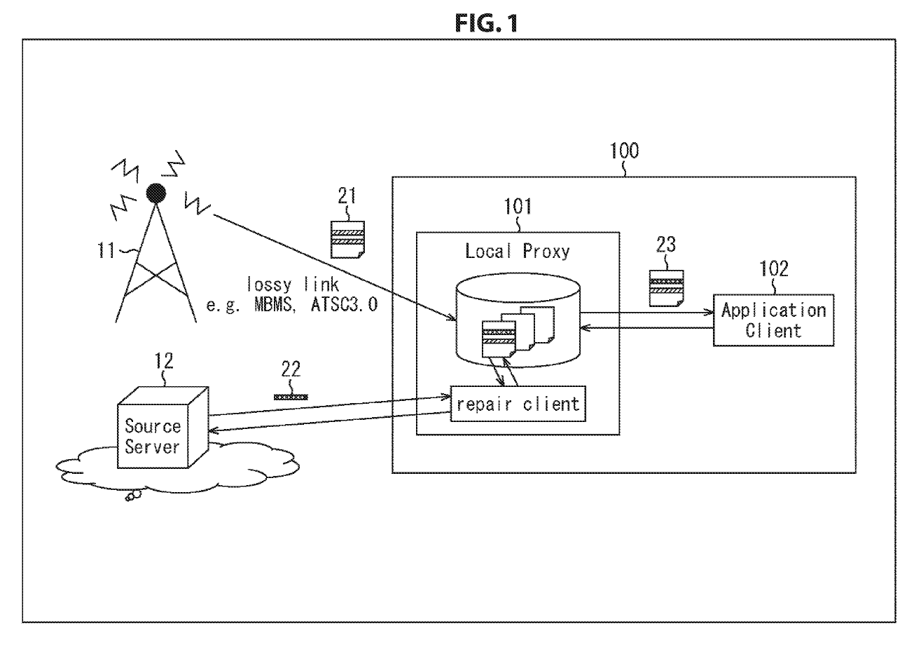

FIG. 1 illustrates a main configuration example of an embodiment of a communication system to which the present technology is applied. The communication system illustrated in FIG. 1 is a system that transmits a file of an image, a sound, or the like, and plays the file at the transmission destination. A reception device 100 is a device that receives data of content such as an image or a sound supplied from a broadcasting station 11, and plays the data. The reception device 100 includes a local proxy 101 and an application client 102. The local proxy 101 is an embodiment of an information processing device to which the present technology is applied, and performs processing related to reception of this data of the content. The application client 102 is an embodiment of an information processing device to which the present technology is applied, and performs processing related to playback of data received by the local proxy 101.

The local proxy 101 acquires and accumulates a file 21 transmitted from the broadcasting station 11 and including data of content. This file 21 is transmitted by a transmission scheme that may involve packet loss or the like, such as multicast/broadcast (MBMS) of a mobile network or broadcasting (e.g., ATSC3.0) (lossy link). Consequently, part of data of this file 21 may have been corrupted at the point in time when the local proxy 101 acquires the file.

In the case where corrupted data (e.g., a hatched portion of the file 21 in FIG. 1) thus occurs in the received file 21, the local proxy 101 can repair the corrupted portion (repair client). For example, the local proxy 101 accesses a file server 12 (also referred to as source server) that provides the file 21, and acquires data 22 (data corresponding to corrupted data) of the corrupted portion of the file 21. Then, the local proxy 101 repairs the corrupted portion of the file 21 by using the data 22.

On the other hand, the application client 102 accesses the local proxy 101 as appropriate, acquires a file to be played (playback file 23) from among files accumulated by the local proxy 101, and plays the file.

When this processing of the application client 102 is made to be performed independently of the above-described repair processing of the local proxy 101, the application client 102 may acquire the playback file 23 whose repair is not finished (the playback file 23 including corrupted data (e.g., a hatched portion of the playback file 23 in FIG. 1)). Although an application client can also perform repair, repair may be delayed because a repair situation cannot be grasped until a file is acquired. There may be a case where repair is not finished in time and playback cannot be performed correctly.

Hence, the local proxy 101 provides, in response to a request for a playback file from the application client 102, information regarding a repair situation of the file. The application client 102 controls acquisition and repair of the file on the basis of the information regarding the repair situation.

### <Local Proxy>

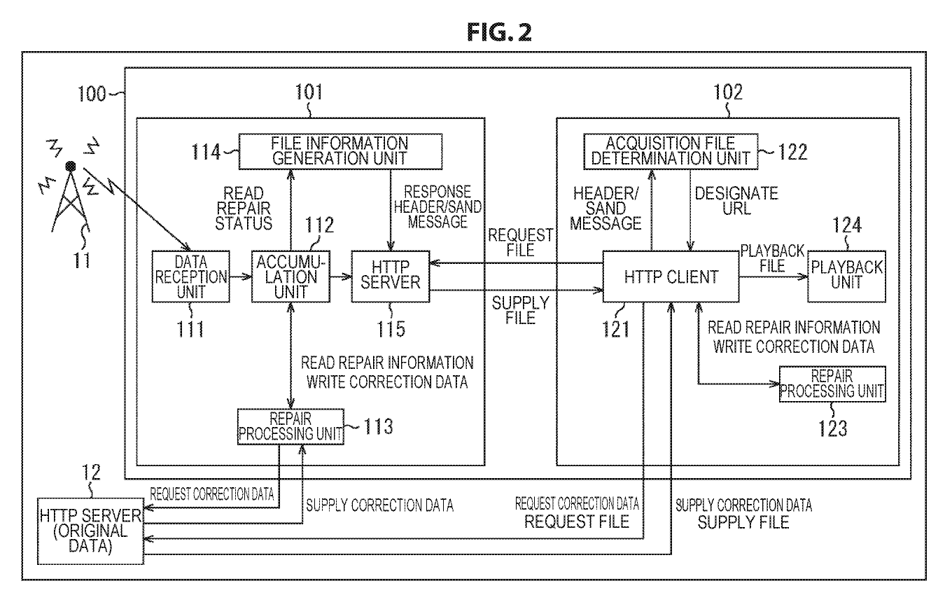

FIG. 2 is a block diagram illustrating a main configuration example of the reception device 100. As illustrated in FIG. 2, the local proxy 101 includes a data reception unit 111, an accumulation unit 112, a repair processing unit 113, a file information generation unit 114, and an HTTP server 115. The data reception unit 111 performs processing related to reception of a file from the broadcasting station 11. The accumulation unit 112 includes any storage medium, and accumulates (stores) files received by the data reception unit 111. The accumulation unit 112 supplies a stored file to any processing unit as needed. The repair processing unit 113 performs processing related to repair of corrupted data of a file. The file information generation unit 114 performs processing related to generation of information regarding a file to be provided to the application client 102 (file information). For example, the file information generation unit 114 acquires, from the accumulation unit 112, information regarding a file requested by the application client 102, information regarding a file related to the file, or both of them, uses the information to generate a response header to be included in a response to a request from the application client 102, a SAND message or a SAND header, or both of them, and supplies it to the HTTP server 115. The HTTP server 115 is an embodiment of a response processing unit to which the present technology is applied, and performs processing related to communication with the application client 102 (an HTTP client 121).

### <Application Client>

In addition, as illustrated in FIG. 2, the application client 102 includes the HTTP client 121, an acquisition file determination unit 122, a repair processing unit 123, and a playback unit 124. The HTTP client 121 is an embodiment of an acquisition unit to which the present technology is applied, and performs processing related to communication with the local proxy 101 (the HTTP server 115) and the file server 12. The acquisition file determination unit 122 is an embodiment of a control unit to which the present technology is applied, and performs processing related to setting of a file acquisition destination. The repair processing unit 123 is an embodiment of a repair unit to which the present technology is applied, and performs processing related to repair of corrupted data of a file. The playback unit 124 performs processing related to playback of a file.

### <Reception and Repair of Data>

The data reception unit 111 receives a file supplied from the broadcasting station 11 or the like. A transmission scheme of this file may be any scheme; it is assumed that data corruption may occur in the file in this file transmission. For example, the file is assumed to be transmitted by a transmission scheme in which packet loss or the like may occur, such as multicast/broadcast (MBMS) of a mobile network or broadcasting (e.g., ATSC3.0). In addition, data included in this file may be any data. For example, the data may be image data or sound data, or may be data other than them. In addition, any format may be used.

On receiving this file, the data reception unit 111 supplies the file to the accumulation unit 112 and causes the file to be stored. In the case where corrupted data exists (a corrupted portion exists in data) in a file accumulated in the accumulation unit 112, the repair processing unit 113 can repair the file.

### <Partial File Container Box>

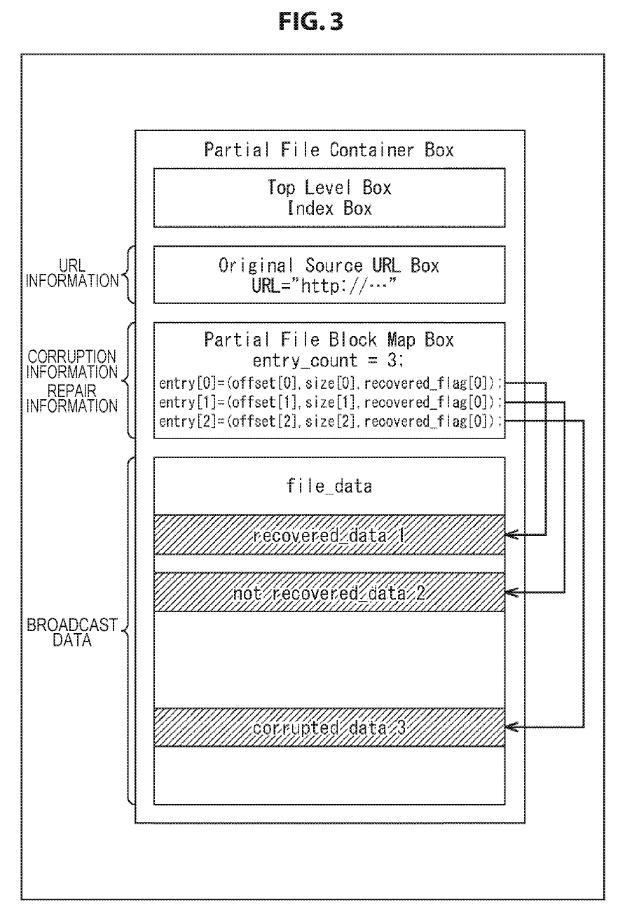

A file accumulated in the accumulation unit 112 is encapsulated by a technique called Partial File Storage that encapsulates file data in which corruption has occurred, in conformity with the ISO base media file format (ISO/IEC 14496-12). In this technique, a file in which corrupted data exists is encapsulated by Partial File Container Box having a box structure of the ISO base media file format, as illustrated in FIG. 3.

Specifically, Partial File Container Box is a top-level box including Top Level Box Index Box, Original Source URL Box, Partial File Block Map Box, and file_data.

In Top Level Box Index Box is described information indicating a position of a box of a predetermined level. In Original Source URL Box is described URL information as acquisition destination information of a file for repair. In Partial File Block Map Box are described corruption information expressing a position and a size of corrupted data, repair information that is information regarding the repair, and the like. file_data is broadcast data in which dummy data is placed in a portion of corrupted data of a file received by the data reception unit 111. Consequently, a size of file_data is the same as a size of a file to be received by the data reception unit 111.

### <Syntax>

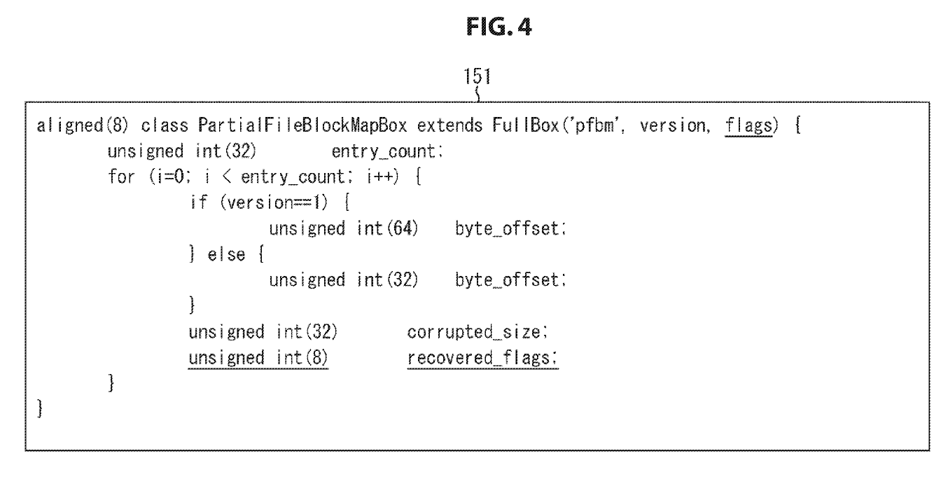

Syntax 151 illustrated in FIG. 4 illustrates an example of syntax of Partial File Block Map Box in FIG. 3. As illustrated in the syntax 151 in FIG. 4, information regarding a data corruption part has one entry for each data block in which corruption has occurred. Moreover, each has a byte offset from the beginning of the file and a size, and also has two types of status flags expressing a situation of repair. Among them, one status flag (flags) expresses a repair situation (a status of repair processing) of the entire file, and the other status flag (recovered_flags) expresses a repair situation (a status of repair processing) of each entry.

### <Semantics>

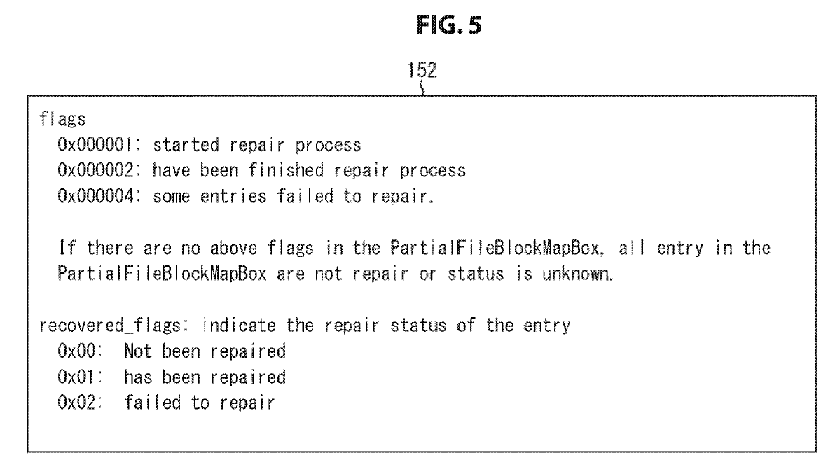

Semantics 152 in FIG. 5 illustrates examples of semantics of these flags (flags, recovered_flags). As illustrated in the semantics 152, the status flag (flags) indicates whether or not repair has been started in a first digit of a binary number, indicates whether or not repair has been finished in a second digit, and indicates whether or not repair has failed in a third digit. In addition, the status flag (recovered_flags) indicates whether or not repair has been performed in a first digit of a binary number, and indicates whether or not repair has failed in a second digit.

### <Flow of File Repair Processing>

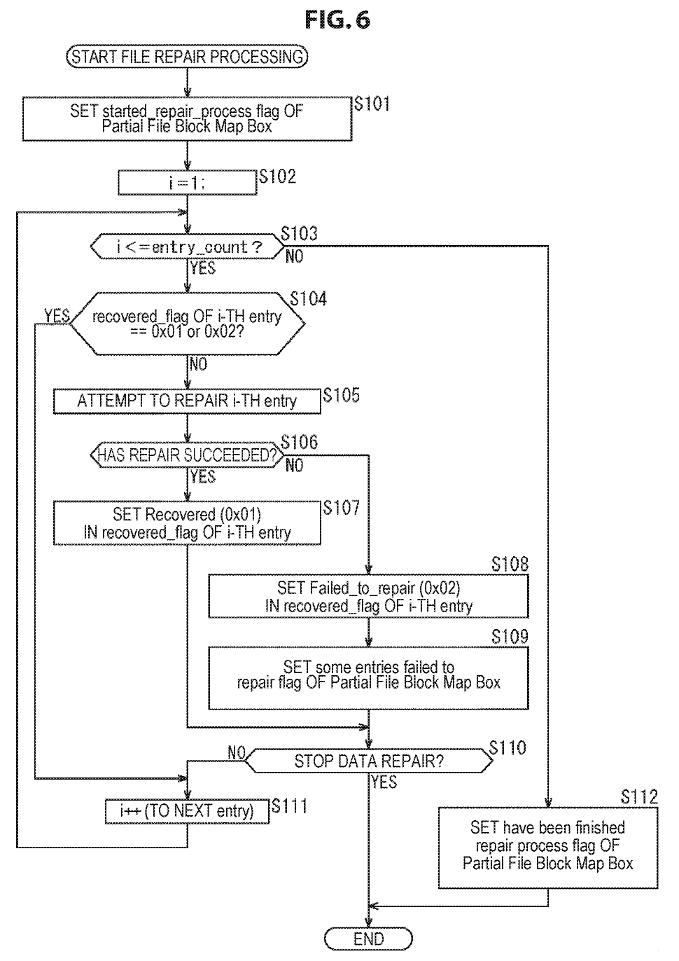

Next, repair of a file by this local proxy 101 is described. The local proxy 101 repairs corrupted data of a file accumulated in the accumulation unit 112 by executing file repair processing. An example of a flow of the file repair processing is described with reference to the flowchart in FIG. 6.

When file repair processing is started, the repair processing unit 113 sets started_repair_process flag of Partial File Block Map Box in step S101. For example, the repair processing unit 113 sets a value of the first digit of the binary number of the status flag (flags) to “1”. In addition, in step S102, the repair processing unit 113 sets a variable i to “1” (initial value).

In step S103, the repair processing unit 113 determines whether or not the variable i is equal to or less than a value of entry count (entry_count). The entry count (entry_count) is a variable indicating the number of pieces of corrupted data (number of entries). In the case where the variable i is equal to or less than a value of entry count (entry_count), processing goes to step S104.

In step S104, the repair processing unit 113 determines whether or not a value of the status flag (recovered_flags) of the i-th entry is 0x01 or 0x02. In the case where it is determined that a value of the status flag (recovered_flags) of the i-th entry is neither 0x01 nor 0x02, that is, in the case where a value of the status flag (recovered_flags) of the i-th entry is 0x00 (repair has not been performed), processing goes to step S105.

In step S105, the repair processing unit 113 attempts to repair the i-th entry. For example, the repair processing unit 113 accesses the file server 12 and requests data (correction data) corresponding to the corrupted data (i-th entry). The file server 12 (also referred to as HTTP server) is a server that provides data of a file supplied by the broadcasting station 11, and supplies requested correction data to the repair processing unit 113 as a response to the correction data request from the repair processing unit 113. The repair processing unit 113 acquires the correction data, and replaces dummy data in the i-th entry with the correction data.

In step S106, the repair processing unit 113 determines whether or not the repair as described above has succeeded. In the case where it is determined that dummy data has been able to be replaced with correct data and repair has succeeded, processing goes to step S107. In step S107, the repair processing unit 113 sets a value “0x01” (Recovered (has been repaired)) in the status flag (recovered_flags) of the i-th entry. When processing in step S107 ends, processing goes to step S110.

In addition, in the case where it is determined that repair has failed in step S106, processing goes to step S108. In step S108, the repair processing unit 113 sets a value “0x02” (Fail_to_repair) in the status flag (recovered_flags) of the i-th entry. Then, in step S109, the repair processing unit 113 sets some entries failed to repair flag of Partial File Block Map Box. For example, the repair processing unit 113 sets a value of the third digit of the binary number of the status flag (flags) to “1”. When processing in step S109 ends, processing goes to step S110.

In step S110, the repair processing unit 113 determines whether or not to stop data repair. For example, in the case where data repair is determined to be stopped by, for example, receiving a request for a file from the application client 102, data repair is stopped, and the file repair processing ends.

In addition, in the case where data repair is determined to be continued in step S110, processing goes to step S111. In addition, in the case where it is determined that a value of the status flag (recovered_flags) of the i-th entry is 0x01 or 0x02 in step S104, that is, in the case where an attempt has been made to repair the i-th entry (regardless of whether or not repair has succeeded), processing goes to step S111. In other words, an attempt to repair this entry is omitted. In step S111, the repair processing unit 113 increments the variable i (i++), and updates a processing target to the next entry. When processing in step S111 ends, processing returns to step S103, and subsequent processing is performed on a new entry to be processed.

Then, in the case where it is determined that the variable i is greater than a value of entry count (entry_count) in step S103, processing goes to step S112. In step S112, the repair processing unit 113 sets have been finished repair process flag of Partial File Block Map Box. For example, the repair processing unit 113 sets a value of the second digit of the binary number of the status flag (flags) to “1”. When processing in step S112 ends, the file repair processing ends.

As described above, the status flag (flags) and the status flag (recovered_flags) of each entry are updated in accordance with a repair situation of corrupted data. Consequently, these status flags indicate up to where repair has been finished, that is, a repair situation.

### <Request for File and Response 1>

The HTTP server 115 communicates with the HTTP client 121 of the application client 102, accepts a request from the HTTP client 121, and sends back a response to the request. For example, when the HTTP client 121 supplies a request for acquisition of a file accumulated in the accumulation unit 112 (file request) to the HTTP server 115, the HTTP server 115 accepts the file request. The file information generation unit 114 creates a header of a response to the request. For example, the file information generation unit 114 acquires, from the accumulation unit 112, information regarding a file requested by the application client 102. This information regarding the file may be any information, and for example, includes corruption information and repair information of the file, more specifically, information regarding a repair situation, such as a status of repair processing or the number of blocks and the number of bytes of corrupted data. The file information generation unit 114 generates a response header by using these pieces of information. In other words, the file information generation unit 114 generates a response header including information regarding a repair situation of the requested file. The file information generation unit 114 supplies the generated response header to the HTTP server 115. The HTTP server 115 acquires the requested file from the accumulation unit 112, generates a response to the request from the application client 102 by using the acquired file and the response header generated by the file information generation unit 114, and sends back the response to the HTTP client 121. In other words, this response includes, in addition to the requested file, information regarding the file, information regarding a repair situation of the file, and the like, for example.

For example, while the repair processing unit 113 of the local proxy 101 is performing repair processing on a partial file as described above, the HTTP server 115 receives a file acquisition request from the application client 102 (the HTTP client 121) attempting to use the file, specifically, an HTTP Request for the URL of the file. Here, it is assumed that the request is designated as “partial file acquirable”.

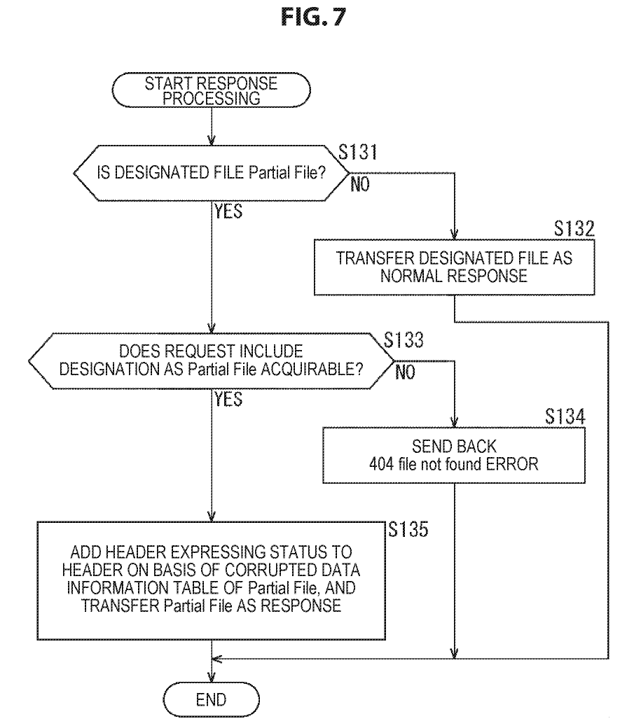

The local proxy 101 executes response processing, and responds to the request (HTTP Request). An example of a flow of this response processing is described with reference to the flowchart in FIG. 7. When response processing is started, the HTTP server 115 determines whether or not a file designated in the request (HTTP Request) is a partial file including corrupted data in step S131. In the case where it is determined that the designated file is not a partial file, processing goes to step S132. In step S132, the HTTP server 115 transfers the designated file to the HTTP client 121 as a normal response (responce). In other words, the requested file is supplied to the application client 102. Note that a header of this response may be generated by the file information generation unit 114. When processing in step S132 ends, the response processing ends.

In the case where it is determined that the designated file is a partial file in step S131, processing goes to step S133. In step S133, the HTTP server 115 determines whether or not the request (HTTP Request) supplied from the HTTP client 121 includes designation as partial file acquirable. In the case where it is determined that designation as partial file acquirable is not included and the application client 102 is unable to acquire a partial file, processing goes to step S134. In step S134, the HTTP server 115 sends back an error notification (404 file not found error) as a response to the request. When processing in step S134 ends, the response processing ends.

In addition, in the case where it is determined that the request (HTTP Request) includes designation as partial file acquirable in step S133, processing goes to step S135. In step S135, the file information generation unit 114 acquires information regarding the file (information regarding a repair situation, etc.) from the accumulation unit 112, and generates a response header by using the information. For example, the file information generation unit 114 generates a header expressing a repair situation, such as a status of repair processing or the number of blocks and the number of bytes of corrupted data, on the basis of a corrupted data information table of the partial file, and adds the header to a response header. The file information generation unit 114 supplies the response header generated in this manner and including the header expressing the repair situation to the HTTP server 115. The HTTP server 115 adds the partial file acquired from the accumulation unit 112 to the response header, and transfers them as a response. In other words, the file information generation unit 114 refers to Partial File Block Map Box of the requested partial file, generates a header including a status flag (flags) and a status flag (recovered_flags) of each entry or information similar to them, and adds the header to the response header. Then, the HTTP server 115 supplies the requested partial file to the HTTP client 121 by a response including the response header. In other words, the HTTP server 115 supplies, together with the partial file, information regarding a repair situation of the partial file to the HTTP client 121.

When processing in step S135 ends, the response processing ends.

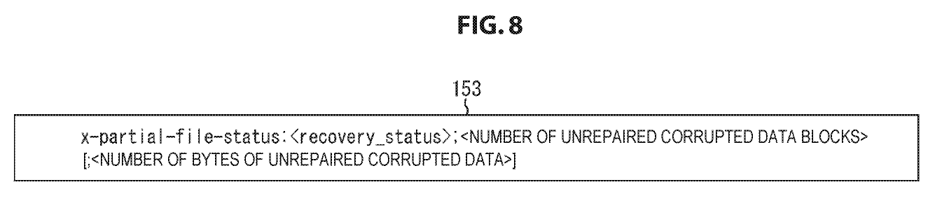

An HTTP extension header 153 in FIG. 8 illustrates an example of a header transferred in step S135 in FIG. 7.

In FIG. 8, x-partial-file-status is an extension header of HTTP, and is a header expressing a repair situation of a partial file. In addition, recovery_status is information designated by a value of the status flag (flags) of PartialFileBlockMapBox in the partial file, and indicates a status of repair processing. For example, in the case where a value of this recovery status is 0x000001, it indicates a state where repair has been started but not finished, that is, the partial file is partly unrepaired. In addition, in the case where a value of this recovery status is 0x000003, it indicates that repair has been started and finished, and the partial file has been completely repaired. In addition, in the case where a value of this recovery status is 0x000007, it indicates that repair processing has been finished but the partial file partly includes a portion that has been unrepairable.

In addition, “number of unrepaired corrupted data blocks” indicate the number of entries in which a value of the status flag (recovered_flags) of each entry of PartialFileBlockMapBox in the partial file is 0x00 (i.e., the number of blocks of corrupted data). The “number of bytes of unrepaired corrupted data” indicates the sum of corrupted_size values of entries in which a value of the status flag (recovered_flags) of each entry of PartialFileBlockMapBox in the partial file is 0x00 (i.e., the number of bytes of corrupted data). Note that this information is optional information, and does not necessarily need to be added to the header.

As described above, the local proxy 101 supplies information regarding a repair situation of a partial file to a request source as a response to a request; thus, the application client 102, which is the request source, can appropriately control acquisition and repair of a file on the basis of the information regarding the repair situation. Consequently, corrupted data of the file can be repaired more easily.

### <Request for File and Response 2>

In addition, in the case where a file requested by the application client 102 is a media segment of MPEG DASH, the local proxy 101 verifies, in advance, whether a subsequent segment of the requested file is a partial file that needs to be repaired, and reports information obtained as a result to the application client 102 by adding the information to a header of a response of the currently requested file, thereby aiding the application client 102 to select the next media segment.

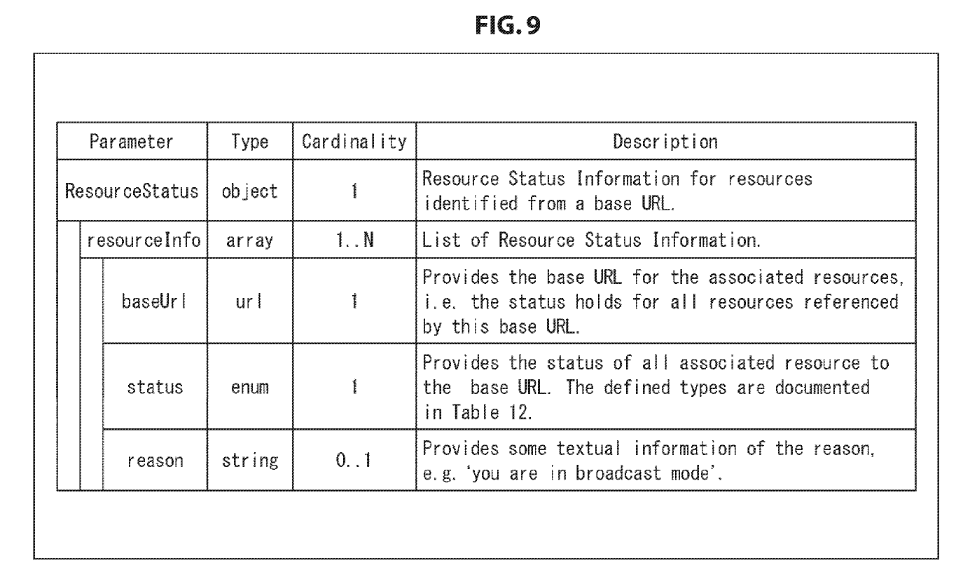

Specifically, SAND, which is an extension of MPEG DASH, prescribes a ResourceStatus message that reports a situation of resources on a server such as a proxy to a DASH client. The table shown in FIG. 9 illustrates an example of a prescription related to the ResourceStatus message of the SAND message of the MPEG DASH. In the case where a file requested by the application client 102 is a media segment of MPEG DASH, the local proxy 101 can use a ResourceStatus message prescribed in this manner to provide a repair status of the subsequent segment as described above to the application client 102. More specifically, information of a file of each media segment can be described as contents of a reason of the ResourceStatus message.

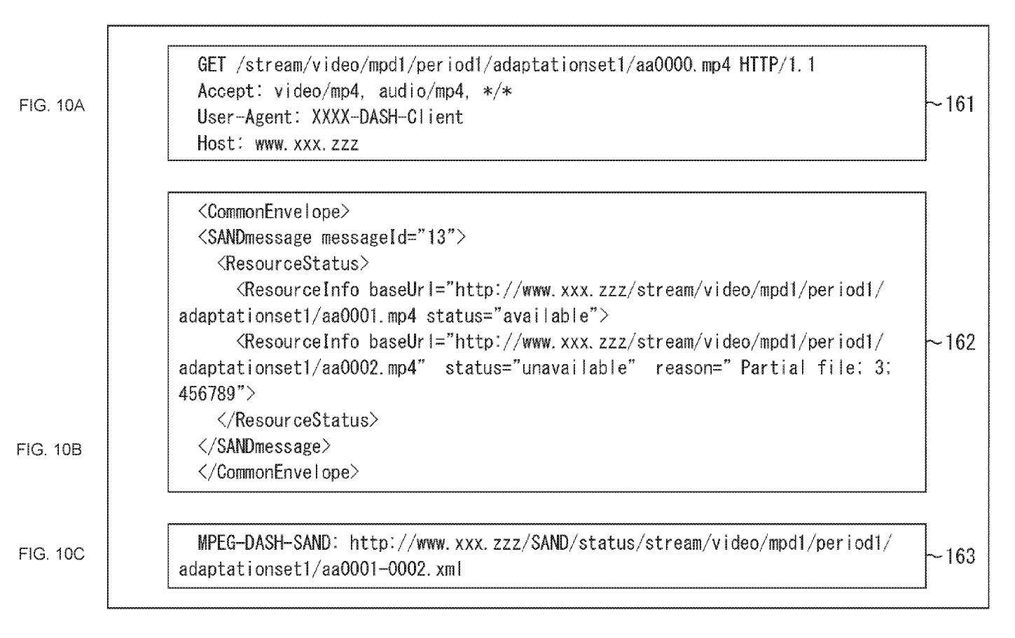

A SAND message is assumed to be expressed in extensible markup language (XML). For example, when an HTTP Request 161 described as illustrated in A of FIG. 10 is supplied from the application client 102, the file information generation unit 114 generates a SAND message 162 as illustrated in B of FIG. 10 in response to the request. Note that a repair situation of a partial file is expressed as a value (string value) of the reason attribute.

For example, in the SAND message 162 illustrated in B of FIG. 10, it is indicated that a status of a file (aa0001.mp4) of a segment subsequent to a segment of a file (aa0000.mp4) designated in the request 161 in A of FIG. 10 is available. In addition, it is indicated that a status of a file (aa0002.mp4) of a further subsequent segment is unavailable. Moreover, the reason indicates a reason therefor (being a partial file, etc.).

Note that such a SAND message is communicated by the application client 102 making a request such as HTTP GET to the URL indicated by an extension header of an HTTP response. A SAND header 163 illustrated in C of FIG. 10 is an example thereof. For example, when the application client 102 supplies an HTTP GET request (e.g., the request 161 in A of FIG. 10) (may be an HTTP HEAD request or may be both of them) to the local proxy 101, the local proxy 101 sends back a response including a SAND header (e.g., the SAND header 163 in C of FIG. 10) to the application client 102. The application client 102 makes HTTP GET on the URL designated in the SAND header, and acquires a SAND message (e.g., the SAND message 162 in B of FIG. 10).

### <Flow of Response Processing>

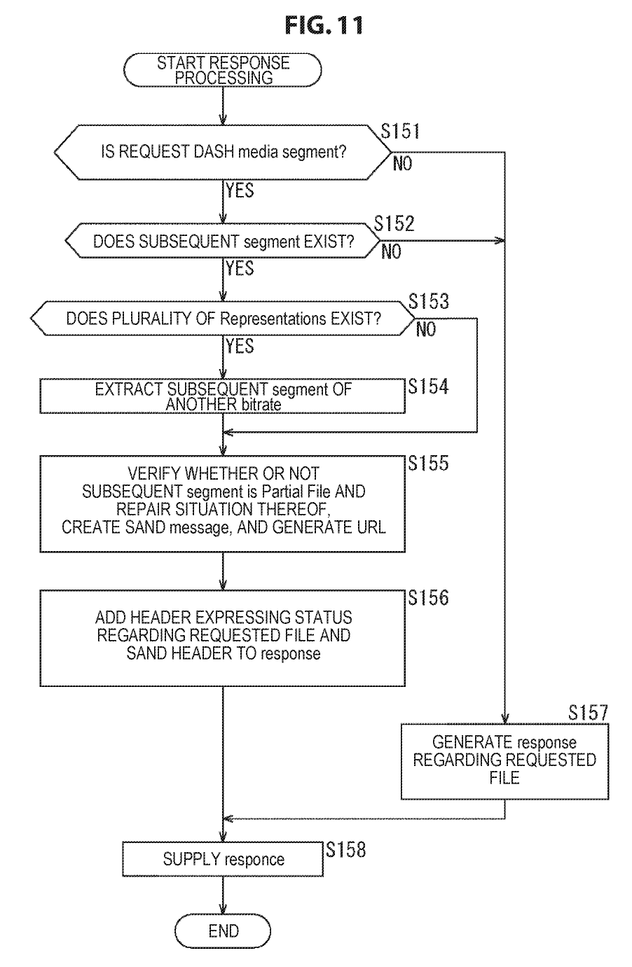

An example of a flow of response processing in this case is described with reference to the flowchart in FIG. 11. When response processing is started, the HTTP server 115 determines whether or not the requested file is a file of a DASH media segment in step S151. In the case where it is determined that the requested file is a file of a DASH media segment, processing goes to step S152. In step S152, the HTTP server 115 determines whether or not a segment subsequent to a segment of a file designated by the request exists. In the case where it is determined that a subsequent segment exists, processing goes to step S153.

In step S153, the HTTP server 115 determines whether or not a plurality of representations exists in an adaptation set (AdaptationSet) to which the representation of the designated file belongs. In the case where it is determined that a plurality of representations exists, processing goes to step S154.

In step S154, the file information generation unit 114 extracts a subsequent segment of another representation (e.g., a representation of another bitrate). When processing in step S154 ends, processing goes to step S155. In addition, in the case where it is determined that a plurality of representations does not exist in step S153, processing in step S154 is omitted, and processing goes to step S155.

In step S155, the file information generation unit 114 verifies whether or not the subsequent segment is a partial file, a repair situation thereof, etc., creates a SAND message on the basis of the verification result, and generates the URL of the SAND message.

In step S156, the file information generation unit 114 generates a header expressing a status regarding the requested file and a SAND header including the URL generated in step S155, and adds them to a response to the request. When processing in step S156 ends, processing goes to step S158.

In addition, in the case where it is determined that the request is not a DASH media segment in step S151, processing goes to step S157. In addition, in the case where it is determined that a subsequent segment does not exist in step S152, processing goes to step S157. In step S157, the file information generation unit 114 and the HTTP server 115 generate a response regarding the requested file. When processing in step S157 ends, processing goes to step S158.

In step S158, the HTTP server 115 supplies the generated response to the application client 102 (the HTTP client 121). When processing in step S158 ends, the response processing ends.

By performing response processing as described above, the local proxy 101 can use a SAND message of MPEG DASH to provide information regarding a repair situation of a file to the application client 102, which is the request source. Thus, information regarding a repair situation of a subsequent segment can also be provided easily. Consequently, the application client 102 can control acquisition and repair of a file earlier on the basis of the information regarding the repair situation, and thus can appropriately control acquisition and repair of the file. Consequently, corrupted data of the file can be repaired more easily.

Note that providing information regarding a repair situation by using an existing SAND message can suppress a reduction in versatility of a message; for example, information regarding a repair situation can be provided to a wider variety of clients, such as an existing HTTP client.

### <Request for File and Response 3>

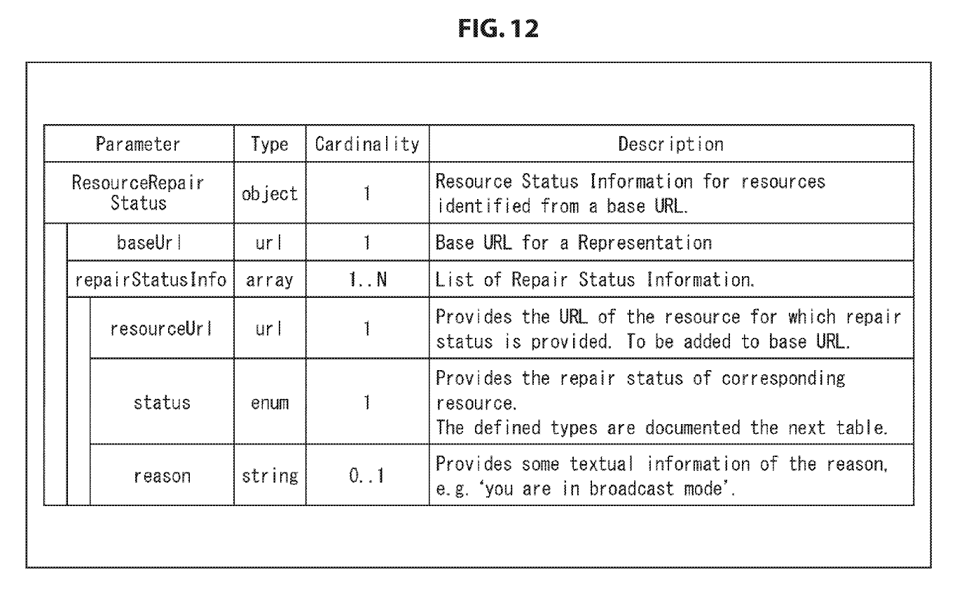

Note that a new message for expressing information regarding a repair situation may be defined, instead of using an existing SAND message (ResourceStatus). For example, as in the table shown in FIG. 12, a new message (ResouceRepairStatus) may be defined, and information regarding a repair situation may be provided by using this ResouceRepairStatus message.

In this case, if the base URL is set as the base URL of a representation, a status related to each media segment belonging to the representation can be expressed by one ResourceRepairStatus element. In addition, describing a plurality of pieces of ResourceRepairStatus together makes it possible to also communicate a status related to a file corresponding to a subsequent segment of another representation in the same adaptation set (AdaptationSet) as the requested representation.

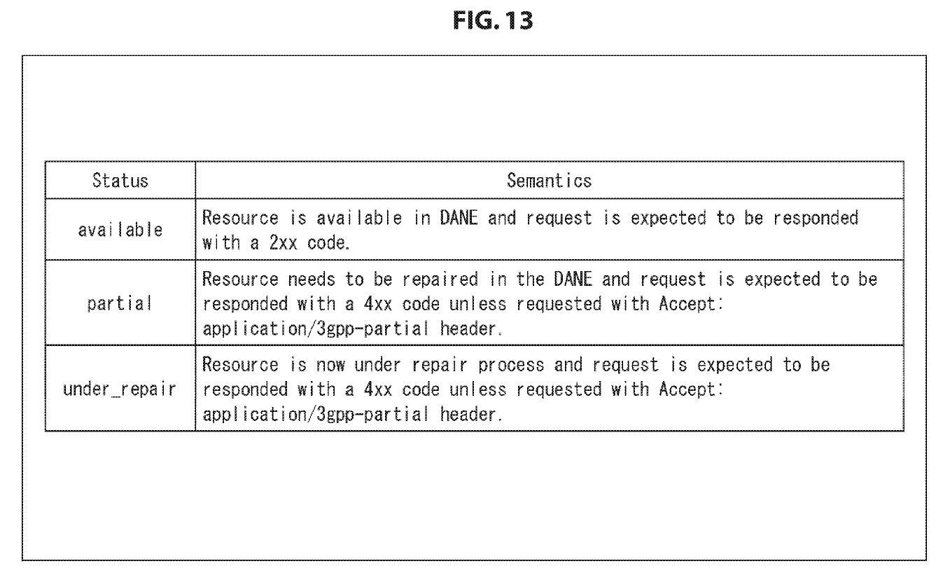

FIG. 13 illustrates an example of semantics of the status. As illustrated in FIG. 13, in this case, one of available, partial, and under_repair can be set as a status. Note that contents of the reason at statuses of partial and under_repair are similar to those in the case of the ResourceStatus message described above.

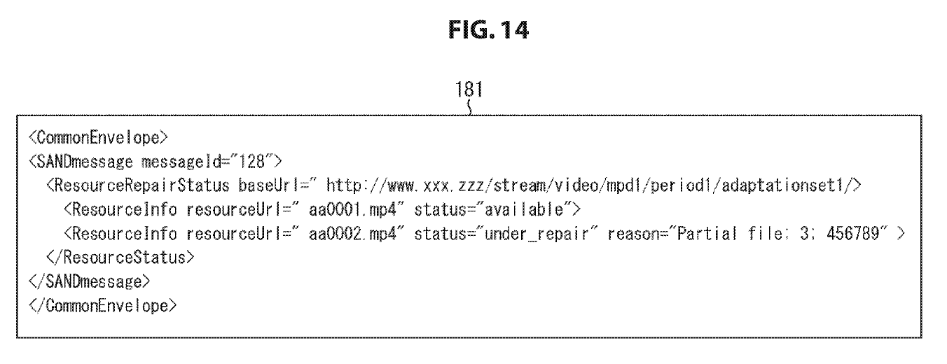

A SAND message 181 illustrated in FIG. 14 illustrates an example of a SAND message extended in this manner. In the example of FIG. 14, it is indicated that a status of a file (aa0001.mp4) of a segment subsequent to a segment designated by a request is available, and that a status of a file (aa0002.mp4) of a further subsequent segment is under_repair. In addition, the reason indicates a reason therefor. Note that also in this case, a SAND header may be similar to that in the case of using an existing SAND message (ResourceStatus).

Extending a SAND message in this manner makes it possible to provide information regarding a repair situation more efficiently (with a smaller amount of information). Consequently, an increase in loads on the client side due to the acquisition of this information regarding the repair situation can be suppressed.

### <File Acquisition Determination>

Next, processing of the application client 102 provided with information regarding a repair situation is described. The application client 102 acquires information supplied as a response to a request and regarding a repair situation of a file with incomplete data, and performs control related to acquisition and repair of a file on the basis of the acquired information regarding the repair situation. Thus, the application client 102 can appropriately control acquisition and repair of the file on the basis of the information regarding the repair situation. Consequently, corrupted data of the file can be repaired more easily.

### <File Acquisition Processing Flow 1>

For example, the acquisition file determination unit 122 of the application client 102 may determine whether to acquire a file from the local proxy 101 and use the file as it is, whether to repair a partial file acquired from the local proxy 101 on its own, whether to acquire the entire file from the file server 12 (HTTP server) having original data, etc.

At this time, the HTTP client 121 may acquire information regarding a repair situation supplied as a header of an HTTP response, and the acquisition file determination unit 122 may perform control related to acquisition and repair of a file on the basis of the information regarding the repair situation included in the header of the HTTP response.

In that case, for example, the acquisition file determination unit 122 may select an acquisition destination of the file on the basis of the proportion of unrepaired corrupted data of the file.

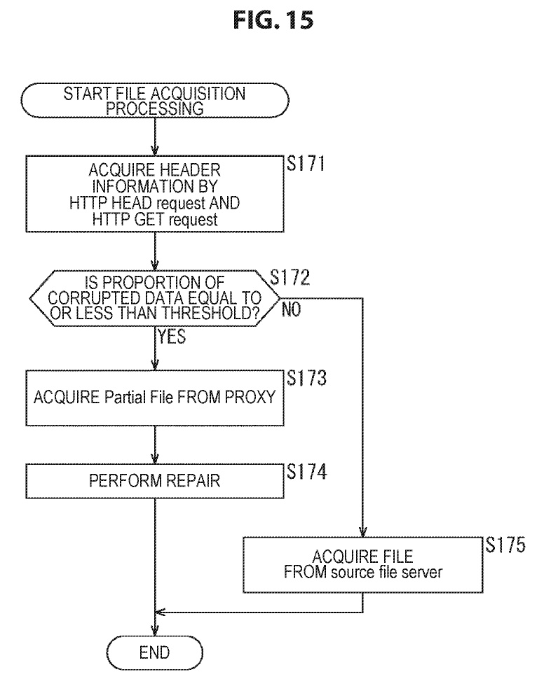

An example of a flow of file acquisition processing executed by the application client 102 in that case is described with reference to the flowchart in FIG. 15. When file acquisition processing is started, the HTTP client 121 of the application client 102 acquires header information of a desired file by an HTTP HEAD request, an HTTP GET request, or both of them in step S171.

In step S172, the acquisition file determination unit 122 determines whether or not the proportion of corrupted data is equal to or less than a predetermined threshold, on the basis of information regarding the number of bytes of corrupted data, or the like included in HTTP header information acquired by the HTTP client 121. Note that a proportion z of corrupted data is calculated as in the following formula (1).

z=(number of bytes of corrupted data)/(number of bytes of entire file) (1)

In the case where it is determined that the proportion z of corrupted data is equal to or less than the predetermined threshold, processing goes to step S173. In this case, the acquisition file determination unit 122 determines to acquire a file from the local proxy 101, and controls the HTTP client 121 in that way. In other words, in step S173, in accordance with the control, the HTTP client 121 acquires a partial file from the local proxy 101.

In step S174, the HTTP client 121 requests data corresponding to corrupted data of the acquired partial file from the file server 12, and acquires the data. The repair processing unit 123 replaces corrupted data corresponding to the data with the data, thereby repairing the partial file. When processing in step S174 ends, the file acquisition processing ends.

In addition, in the case where it is determined that the proportion z of corrupted data is greater than the predetermined threshold in step S172, processing goes to step S175. In this case, the acquisition file determination unit 122 determines to acquire the entire file without corruption from the file server 12, and controls the HTTP client 121 in that way. In other words, in step S175, in accordance with the control, the HTTP client 121 acquires the entire file from the file server 12 (source file server). When processing in step S175 ends, the file acquisition processing ends.

By performing file acquisition processing as described above, the application client 102 can appropriately control acquisition and repair of a file on the basis of information regarding a repair situation included in a header of an HTTP response. Consequently, corrupted data of the file can be repaired more easily.

### <File Acquisition Processing Flow 2>

In addition, for example, the acquisition file determination unit 122 may select an acquisition destination of a file further on the basis of the number of blocks of unrepaired corrupted data of the file.

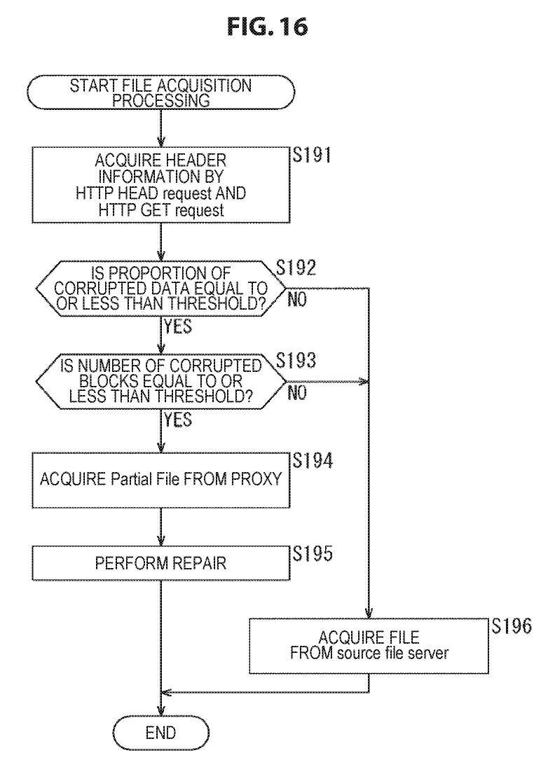

An example of a flow of file acquisition processing executed by the application client 102 in that case is described with reference to the flowchart in FIG. 16. When file acquisition processing is started, the HTTP client 121 of the application client 102 acquires header information of a desired file by an HTTP HEAD request, an HTTP GET request, or both of them in step S191.

In step S192, the acquisition file determination unit 122 determines whether or not the proportion of corrupted data is equal to or less than a predetermined threshold, on the basis of information regarding the number of bytes of corrupted data, or the like included in HTTP header information acquired by the HTTP client 121. Note that also in this case, a proportion z of corrupted data is calculated as in the above formula (1).

In the case where it is determined that the proportion z of corrupted data is equal to or less than the predetermined threshold, processing goes to step S193. In step S193, the acquisition file determination unit 122 determines whether or not the number of blocks of corrupted data is equal to or less than a predetermined threshold on the basis of information regarding the number of blocks of corrupted data, or the like included in HTTP header information acquired by the HTTP client 121. In the case where it is determined that the number of blocks of corrupted data is equal to or less than the predetermined threshold, processing goes to step S194.

In this case, the acquisition file determination unit 122 determines to acquire a file from the local proxy 101, and controls the HTTP client 121 in that way. In other words, in step S194, in accordance with the control, the HTTP client 121 acquires a partial file from the local proxy 101.

In step S195, the HTTP client 121 requests data corresponding to corrupted data of the acquired partial file from the file server 12, and acquires the data. The repair processing unit 123 replaces corrupted data corresponding to the data with the data, thereby repairing the partial file. When processing in step S195 ends, the file acquisition processing ends.

In addition, in the case where it is determined that the proportion z of corrupted data is greater than the predetermined threshold in step S192, processing goes to step S196. In addition, in the case where it is determined that the number of blocks of corrupted data is greater than the predetermined threshold in step S193, processing goes to step S196. In this case, the acquisition file determination unit 122 determines to acquire the entire file without corruption from the file server 12, and controls the HTTP client 121 in that way. In other words, in step S196, in accordance with the control, the HTTP client 121 acquires the entire file from the file server 12 (source file server). When processing in step S196 ends, the file acquisition processing ends.

A pseudo code of such file acquisition processing is as follows. It is to be noted that the threshold of the proportion z of corrupted data is set to 0.3, and the threshold of the number of blocks of corrupted data is set to 4.
If (z<0.3 && y<4) {
Go to Proxy;
} else {
Go to source file server;
}

By performing file acquisition processing as described above, the application client 102 can appropriately control acquisition and repair of a file on the basis of information regarding a repair situation included in a header of an HTTP response. Consequently, corrupted data of the file can be repaired more easily.

### <File Acquisition Processing Flow 3>

The HTTP client 121 may acquire information regarding a repair situation supplied as a SAND message of MPEG DASH. In addition, in that case, the acquisition file determination unit 122 may cause a file to be acquired after waiting in accordance with surplus time before playback of the file.

The application client 102 attempting to acquire a series of segment files in streaming of MPEG DASH can decide an acquisition destination of a subsequent media segment in accordance with a status of a file accumulated in the local proxy 101 provided by a SAND message.

Basically, the determination is similar to that in the case of information obtained by the HTTP header described above; however, since information regarding a media segment file to be requested in the future is also obtained in a SAND message, determination in accordance with the information is also possible. For example, determination can be made as follows, for example: in the case where it is found that the immediately following segment has a partial or under_repair status, the file server 12 is accessed for acquisition of the segment in advance, whereas in the case where the segment is a segment that is some time ahead, when an amount of data requiring repair is equal to or less than a certain amount even though the status is an under_repair status, an attempt for additional acquisition from the file server 12 is not made, with the expectation that repair will be completed before the segment is actually acquired.

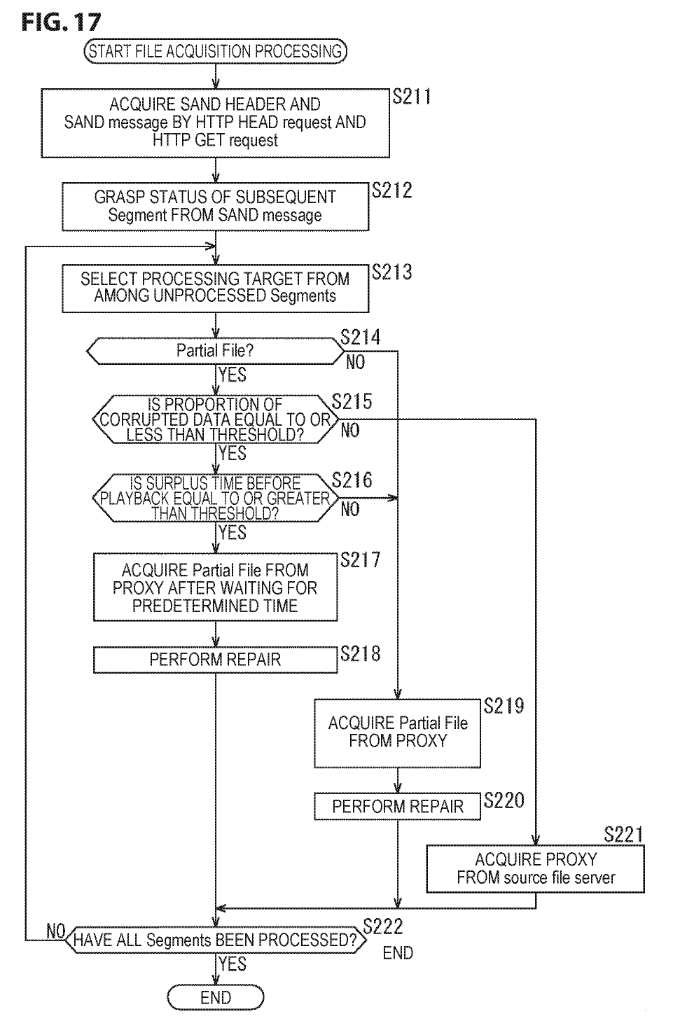

An example of a flow of file acquisition processing in this case is described with reference to the flowchart in FIG. 17. When file acquisition processing is started, the HTTP client 121 of the application client 102 acquires a SAND header by an HTTP HEAD request, an HTTP GET request, or both of them in step S211, and makes an HTTP GET request on the URL described in the SAND header, thereby acquiring a SAND message. In step S212, the acquisition file determination unit 122 grasps a status of a subsequent segment from the SAND message acquired by the HTTP client 121.

In step S213, the acquisition file determination unit 122 selects a processing target from among unprocessed segments. In step S214, the acquisition file determination unit 122 determines whether or not a file of the segment to be processed is a partial file. In the case where it is determined that the file is a partial file, processing goes to step S215.

In step S215, the acquisition file determination unit 122 determines whether or not the proportion z of corrupted data of the file of the segment to be processed is equal to or less than a predetermined threshold. In the case where it is determined that the proportion z of corrupted data is equal to or less than the predetermined threshold, processing goes to step S216. In step S216, the acquisition file determination unit 122 determines whether or not surplus time before playback of the file of the segment to be processed is equal to or greater than a predetermined threshold. In the case where it is determined that the surplus time is equal to or greater than the predetermined threshold, processing goes to step S217.

In this case, the acquisition file determination unit 122 causes the HTTP client 121 to wait without making an attempt for acquisition from the file server 12, with the expectation that repair will be completed before the segment is actually acquired. Then, the acquisition file determination unit 122 determines to cause the file to be acquired from the local proxy 101 at timing corresponding to playback timing, and controls the HTTP client 121 in that way. In other words, in step S217, in accordance with the control, the HTTP client 121 acquires a partial file from the local proxy 101 after waiting for predetermined time.

In step S218, the HTTP client 121 requests data corresponding to corrupted data of the acquired partial file from the file server 12, and acquires the data. The repair processing unit 123 replaces corrupted data corresponding to the data with the data, thereby repairing the partial file. When processing in step S218 ends, processing goes to step S222.

In addition, in the case where it is determined that the file of the segment to be processed is not a partial file in step S214, processing goes to step S219. In addition, in the case where it is determined that surplus time before playback is shorter than the threshold in step S216, processing goes to step S219.

In this case, the acquisition file determination unit 122 determines to cause the file of the segment to be processed to be acquired from the local proxy 101, and controls the HTTP client 121 in that way.

In other words, in step S219, in accordance with the control, the HTTP client 121 acquires a file from the local proxy 101. Then, in the case where the acquired file is a partial file, in step S220, the HTTP client 121 requests data corresponding to corrupted data of the partial file from the file server 12, and acquires the data. The repair processing unit 123 replaces corrupted data corresponding to the data with the data, thereby repairing the partial file. When processing in step S220 ends, processing goes to step S222. Note that in the case where the file acquired from the local proxy 101 is not a partial file, processing in step S220 is omitted.

In addition, in the case where it is determined that the proportion z of corrupted data is greater than the predetermined threshold in step S215, processing goes to step S221.

In this case, the acquisition file determination unit 122 determines to acquire the entire file of the segment to be processed from the file server 12, and controls the HTTP client 121 in that way. In other words, in step S221, in accordance with the control, the HTTP client 121 acquires the entire file from the file server 12 (source file server). When processing in step S221 ends, processing goes to step S222.

In step S222, the HTTP client 121 determines whether or not all segments have been processed. In the case where it is determined that an unprocessed segment exists, processing returns to step S213, and subsequent processing is repeated. That is, processing in steps S213 to S222 is executed on each segment. Then, in the case where it is determined that all the segments that can be subjected to processing have been processed in step S222, the file acquisition processing ends.

By performing file acquisition processing as described above, the application client 102 can acquire information provided by using a SAND message of MPEG DASH and regarding a repair situation of a file. Thus, information regarding a repair situation of a subsequent segment, a segment of another representation, etc. can also be acquired easily. Consequently, the application client 102 can control acquisition and repair of a file earlier on the basis of the information regarding the repair situation, and thus can more appropriately control acquisition and repair of the file. Consequently, corrupted data of the file can be repaired more easily.

Note that as described above, information regarding a repair situation of a file may be transmitted by using an existing SAND message, or a new message for expressing information regarding a repair situation may be defined by extending a SAND message, and information regarding a repair situation of a file may be transmitted by using the new message. In the case of using an existing SAND message, it is sufficient if the application client 102 has a function capable of understanding an existing SAND message, and in the case of extending a SAND message, it is sufficient if the application client 102 has a function capable of understanding the extension message.

### 2. Others

### <Application Example>

Described above is communication between the local proxy 101 and the application client 102 in the reception device 100; however, the present technology is not limited to this, and can also be applied to communication between devices, for example. In other words, the local proxy 101 and the application client 102 may be configured in any devices different from each other.

For example, in a local area network (LAN), the local proxy 101 may be configured in a local server, a router, a hub, a broadcast wave receiver, a relay device, an access point, or the like, and the application client 102 may be configured in a terminal device operated by a user. In addition, without being limited to a LAN, for example, the local proxy 101 may be configured in a contents delivery network (CDN) edge server or the like on the Internet, and the application client 102 may be configured in a local server, a router, a hub, a broadcast wave receiver, a relay device, an access point, a terminal device, or the like. Even in the case where the present technology is applied to communication between devices as described above, an effect similar to that in the case described in the first embodiment can be obtained.

Note that the number of the local proxies 101 and the number of the application clients 102 may be any number, and do not need to have a one-to-one relationship. For example, a plurality of application clients 102 may access a single local proxy 101. Conversely, a single application client 102 may access a plurality of local proxies 101. In other words, any number of application clients 102 may be able to access any number of local proxies 101.

In addition, data stored in a file to be transmitted may be any data. For example, the data may be image data, sound data, or data other than an image or a sound, such as text data, for example. In addition, a plurality of types of data, such as image data, sound data, and metadata thereof, for example, may be stored in one file, of course. In addition, a format of data may be any format.

In addition, the application client 102 may supply a repaired file to another device or another processing unit or cause a storage unit to store the file, without playing the file. For example, the first embodiment describes that the local proxy 101 and the application client 102 are formed in the reception device 100; however, the local proxy 101 and the application client 102 may be formed in any server, such as a CDN edge server or a local server, for example, or may be formed in any communication device, such as a router, a hub, a relay device, or an access point.

### <Fields to Which the Present Technology is Applied>

A system, a device, a processing unit, or the like to which the present technology is applied can be used in any field, such as traffic, medical care, crime prevention, agriculture, stockbreeding, mining, beauty care, factories, home electrical appliances, weather, and nature observation, for example.

For example, the present technology can be applied to a system or a device that transmits images used for appreciation. In addition, for example, the present technology can be applied to a system or a device used for traffic. Furthermore, for example, the present technology can be applied to a system or a device used for security. In addition, for example, the present technology can be applied to a system or a device used for sports. Furthermore, for example, the present technology can be applied to a system or a device used for agriculture. In addition, for example, the present technology can be applied to a system or a device used for stockbreeding. Furthermore, the present technology can be applied to a system or a device that observes a condition of nature, such as volcanos, forests, or oceans, for example. In addition, the present technology can be applied to a weather observation system or a weather observation device that observes weather, temperature, humidity, wind velocity, sunshine duration, or the like, for example. Furthermore, the present technology can be applied to a system or a device that observes the ecology of wildlife, such as Ayes, Pisces, reptiles, amphibians, mammals, insects, or plants, for example.

### <Computer>

The series of processes described above can be executed by hardware, and can also be executed in software. In the case of executing the series of processes by software, a program forming the software is installed on a computer. Herein, the term computer includes a computer built into special-purpose hardware, a computer able to execute various functions by installing various programs thereon, such as a general-purpose personal computer, for example, and the like.

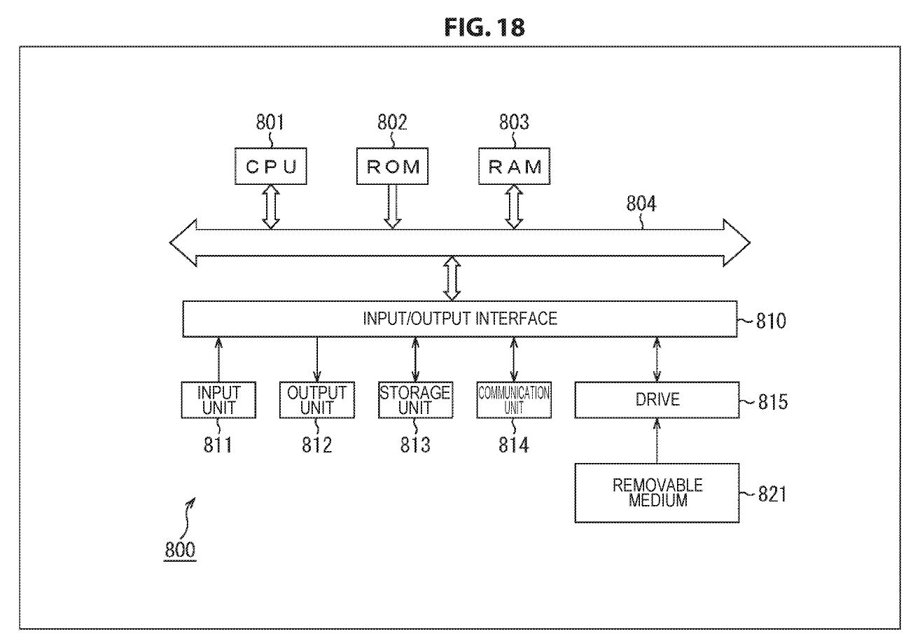

FIG. 18 is a block diagram illustrating an exemplary hardware configuration of a computer that executes the series of processes described above according to a program.

In the computer 800 illustrated in FIG. 18, a central processing unit (CPU) 801, read-only memory (ROM) 802, and random access memory (RAM) 803 are interconnected through a bus 804.

Additionally, an input/output interface 810 is also connected to the bus 804. An input unit 811, an output unit 812, a storage unit 813, a communication unit 814, and a drive 815 are connected to the input/output interface 810.

The input unit 811 includes a keyboard, a mouse, a microphone, a touch panel, an input terminal, and the like, for example. The output unit 812 includes a display, a speaker, an output terminal, and the like, for example. The storage unit 813 includes a hard disk, a RAM disk, non-volatile memory, and the like, for example. The communication unit 814 includes a network interface, for example. The drive 815 drives a removable medium 821 such as a magnetic disk, an optical disc, a magneto-optical disc, or semiconductor memory.

In the computer 800 configured as above, the series of processes described above are performed by having the CPU 801 load a program stored in the storage unit 813 into the RAM 803 via the input/output interface 810 and the bus 804, and execute the program, for example. Additionally, data required for the CPU 801 to execute various processes and the like is also stored in the RAM 803 as appropriate.

The program executed by the computer 800 may be applied by being recorded onto the removable medium 821 as packaged media or the like, for example. In this case, the program may be installed in the storage unit 813 via the input/output interface 810 by inserting the removable medium 821 into the drive 815. In addition, the program may also be provided via a wired or wireless transmission medium such as a local area network, the Internet, or digital satellite broadcasting. In this case, the program may be received by the communication unit 814 and installed in the storage unit 813. Otherwise, the program may be preinstalled in the ROM 802, the storage unit 813, or the like.

### <Others>

An embodiment of the present technology is not limited to the embodiments described above, and various changes and modifications may be made without departing from the scope of the present technology.

For example, in this specification, a system means a set of a plurality of constituent elements (e.g., devices or modules (parts)), regardless of whether or not all the constituent elements are in the same housing. Accordingly, a plurality of devices that is contained in different housings and connected via a network and one device in which a plurality of modules is contained in one housing are both systems.

Further, for example, an element described as a single device (or processing unit) may be divided and configured as a plurality of devices (or processing units). Conversely, elements described as a plurality of devices (or processing units) above may be configured collectively as a single device (or processing unit). Further, an element other than those described above may be added to the configuration of each device (or processing unit). Furthermore, a part of the configuration of a given device (or processing unit) may be included in the configuration of another device (or another processing unit) as long as the configuration or operation of the system as a whole is substantially the same.

In addition, for example, the present technology can adopt a configuration of cloud computing which performs processing by allocating and sharing one function by a plurality of devices through a network.

In addition, for example, the program described above can be executed in any device. In that case, it is sufficient if the device has a necessary function (functional block etc.) and can obtain necessary information.

In addition, for example, each step described by the above-described flowcharts can be executed by one device or executed by being allocated to a plurality of devices. Furthermore, in the case where a plurality of processes is included in one step, the plurality of processes included in this one step can be executed by one device or executed by being allocated to a plurality of devices. In other words, a plurality of processes included in one step can be executed as processing of a plurality of steps. Conversely, processing described as a plurality of steps can be executed collectively as one step.

Note that in a program executed by a computer, processing in steps describing the program may be executed chronologically along the order described in this specification, or may be executed concurrently, or individually at necessary timing such as when a call is made. In other words, unless a contradiction arises, processing in the steps may be executed in an order different from the order described above. Furthermore, processing in steps describing the program may be executed concurrently with processing of another program, or may be executed in combination with processing of another program.

In addition, processing in the steps described above can be executed in each device described above or any device other than the devices described above. In that case, it is sufficient if the device that executes the processing has the above-described function (functional block etc.) necessary for executing the processing. In addition, it is sufficient if information necessary for processing is transmitted to the device as appropriate.

Note that the plurality of present technologies described in this specification can be performed alone independently of each other, unless a contradiction arises. Of course, any plurality of the present technologies can be performed in combination. For example, part or the whole of the present technology described in any of the embodiments can be performed in combination with part or whole of the present technology described in another embodiment. In addition, part or the whole of any of the present technologies described above can be performed in combination with another technology that is not described above.

Additionally, the present technology may also be configured as below.

(1)

An information processing device including:

a response processing unit configured to provide, as a response to a request related to a file with incomplete data, information regarding a repair situation of the file to a request source.

(2)

The information processing device according to (1), in which the information regarding the repair situation includes

a status of repair processing of the file, and

information indicating the number of blocks of unrepaired corrupted data of the file.

(3)

The information processing device according to (2), in which the status includes

information indicating whether or not repair has been started,

information indicating whether or not repair has been finished, and

information indicating whether or not repair has failed.

(4)

The information processing device according to (2) or (3), in which the information regarding the repair situation further includes information indicating the number of bytes of unrepaired corrupted data of the file.

(5)

The information processing device according to any one of (1) to (4), in which the response processing unit provides the information regarding the repair situation of the file to the request source by adding the information to a header of the response as a HyperText Transfer Protocol (HTTP) header.

(6)

The information processing device according to any one of (1) to (5), in which the response processing unit provides the information regarding the repair situation of the file to the request source as a Server and network assisted DASH (SAND) message of Moving Picture Experts Group Dynamic Adaptive Streaming over HyperText Transfer Protocol (MPEG DASH).

(7)

The information processing device according to (6), in which the response processing unit further provides information regarding a repair situation of a file of another segment, in addition to information regarding a repair situation of a file of a requested segment, by the SAND message.

(8)

The information processing device according to (6) or (7), in which the response processing unit provides the information regarding the repair situation of the file by using a ResourceStatus message of the SAND message.

(9)

The information processing device according to (6) or (7), in which the response processing unit provides the information regarding the repair situation of the file by using an extension message of the SAND message.

(10)

An information processing method including:

providing, as a response to a request related to a file with incomplete data, information regarding a repair situation of the file to a request source.

(11)

An information processing device including:

an acquisition unit configured to acquire information regarding a repair situation of a file with incomplete data, the information being supplied as a response to a request; and

a control unit configured to perform control related to acquisition of the file, on the basis of the information regarding the repair situation acquired by the acquisition unit.

(12)

The information processing device according to (11),

in which the control unit selects, on the basis of the information regarding the repair situation, an acquisition destination of the file from a supply source of the file and a supply source of the response to which the file is supplied from the supply source of the file, and

the acquisition unit further acquires the file from the acquisition destination selected by the control unit.

(13)

The information processing device according to (12), in which the control unit selects the acquisition destination of the file on the basis of a proportion of unrepaired corrupted data of the file.

(14)

The information processing device according to (13), in which the control unit selects the acquisition destination of the file further on the basis of the number of blocks of unrepaired corrupted data of the file.

(15)

The information processing device according to any one of (12) to (14), further including

a repair unit configured to repair unrepaired corrupted data of the file,

in which in a case where the control unit selects the supply source of the response as the acquisition destination of the file,

the acquisition unit acquires the file from the supply source of the response, and further acquires data corresponding to the corrupted data from the supply source of the file, and

the repair unit repairs corrupted data of the file acquired by the acquisition unit by using the data acquired by the acquisition unit.

(16)

The information processing device according to any one of (11) to (15), in which the acquisition unit acquires the information regarding the repair situation supplied as a HyperText Transfer Protocol (HTTP) header.

(17)

The information processing device according to any one of (11) to (16), in which the acquisition unit acquires the information regarding the repair situation supplied as a Server and network assisted DASH (SAND) message of Moving Picture Experts Group Dynamic Adaptive Streaming over HyperText Transfer Protocol (MPEG DASH).

(18)

The information processing device according to (17), in which the control unit causes the file to be acquired after waiting in accordance with surplus time before playback of the file.

(19)

The information processing device according to any one of (11) to (18), in which the acquisition unit acquires the information regarding the repair situation supplied as a response to a HyperText Transfer Protocol (HTTP) HEAD Request or an HTTP GET Request.

(20)

An information processing method including:

acquiring information regarding a repair situation of a file with incomplete data, the information being supplied as a response to a request; and

performing control related to acquisition of the file, on the basis of the acquired information regarding the repair situation.

### REFERENCE SIGNS LIST

100 reception device
101 local proxy
102 application client
111 data reception unit
112 accumulation unit
113 repair processing unit
114 file information generation unit
115 HTTP server
121 HTTP client
122 acquisition file determination unit
123 repair processing unit
124 playback unit

1. An information processing device comprising:
a response processing unit configured to provide, as a response to a request related to a file, information regarding a repair situation of the file to a request source of the request, the information including a status of repair processing and information indicating a number of blocks of unrepaired corrupted data.

2. The information processing device according to claim 1,
wherein the status includes
information indicating whether or not repair has been started,
information indicating whether or not repair has been finished, and
information indicating whether or not repair has failed.

3. The information processing device according to claim 2, wherein the response processing unit provides information regarding the repair situations of files of a requested segment and another segment to the request source by using a ResourceStatus message of a Server and network assisted DASH (SAND) message of Moving Picture Experts Group Dynamic Adaptive Streaming over HyperText Transfer Protocol (MPEG DASH).

4. The information processing device according to claim 2, wherein the response processing unit provides information regarding the repair situations of files of a requested segment and another segment to the request source by using an extension message of a Server and network assisted DASH (SAND) message of Moving Picture Experts Group Dynamic Adaptive Streaming over HyperText Transfer Protocol (MPEG DASH).

5. The information processing device according to claim 4, wherein the extension message sets a base URL as a base URL of a representation, thereby expressing a status related to each media segment belonging to the representation.

6. The information processing device according to claim 4, wherein a status related to a file corresponding to a subsequent segment of another representation in a same adaptation set as a requested representation is additionally communicated by describing a plurality of the extension messages together.

7. The information processing device according to claim 1, wherein the information regarding the repair situation further includes information indicating a number of bytes of unrepaired corrupted data of the file.

8. The information processing device according to claim 1, wherein the response processing unit provides the information regarding the repair situation to the request source by adding the information to a header of the response as a HyperText Transfer Protocol (HTTP) header.

9. An information processing method, comprising:
providing, as a response to a request related to a file, information regarding a repair situation of the file to a request source of the request, the information including a status of repair processing and information indicating a number of blocks of unrepaired corrupted data.

10. An information processing device, comprising:
an acquisition unit configured to acquire information regarding a repair situation of a file, the information being supplied as a response to a request related to the file and including a status of repair processing and information indicating a number of blocks of unrepaired corrupted data; and
a control unit configured to perform control related to acquisition of the file, on a basis of the information regarding the repair situation acquired by the acquisition unit.

11. The information processing device according to claim 10,
wherein the control unit selects, on a basis of the information regarding the repair situation, an acquisition destination of the file from a supply source of the file and a supply source of the response to which the file is supplied from the supply source of the file, and
the acquisition unit further acquires the file from the acquisition destination selected by the control unit.

12. The information processing device according to claim 11,
wherein the control unit selects the acquisition destination of the file on a basis of a proportion of unrepaired corrupted data of the file.

13. The information processing device according to claim 12, wherein the control unit selects the acquisition destination of the file further on a basis of a number of blocks of unrepaired corrupted data of the file.

14. The information processing device according to claim 11, further comprising
a repair unit configured to repair unrepaired corrupted data of the file,
wherein in a case where the control unit selects the supply source of the response as the acquisition destination of the file,
the acquisition unit acquires the file from the supply source of the response, and further acquires data corresponding to the corrupted data from the supply source of the file, and
the repair unit repairs corrupted data of the file acquired by the acquisition unit by using the data acquired by the acquisition unit.

15. The information processing device according to claim 10, wherein the acquisition unit acquires the information regarding the repair situation supplied as a HyperText Transfer Protocol (HTTP) header.

16. The information processing device according to claim 10, wherein the acquisition unit acquires the information regarding the repair situation supplied as a Server and network assisted DASH (SAND) message of Moving Picture Experts Group Dynamic Adaptive Streaming over HyperText Transfer Protocol (MPEG DASH).

17. The information processing device according to claim 16, wherein the control unit causes the file to be acquired after waiting in accordance with surplus time before playback of the file.

18. The information processing device according to 10, wherein the acquisition unit acquires the information regarding the repair situation supplied as a response to a HyperText Transfer Protocol (HTTP) HEAD Request or an HTTP GET Request.

19. An information processing method comprising:
acquiring information regarding a repair situation of a file, the information being supplied as a response to a request related to the file and including a status of repair processing and information indicating a number of blocks of unrepaired corrupted data; and
performing control related to acquisition of the file, on a basis of the acquired information regarding the repair situation.

20. (canceled)
